(19) United States
(12) Patent Application Publication
(10) Pub. No.: US 2026/0289834 A1
(43) Pub. Date: Sep. 24, 2026

(54) DISPLAY METHOD AND APPARATUS FOR NAVIGATION INFORMATION, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Shengjun LIAO, Shenzhen (CN); Zhang CHEN, Shenzhen (CN); Bo TANG, Shenzhen (CN)

(21) Appl. No.: 19/691,216

(22) Filed: May 28, 2026

Related U.S. Application Data
(63) Continuation of application No. PCT/CN2025/082961, filed on Mar. 17, 2025.

(30) Foreign Application Priority Data
Apr. 8, 2024 (CN) 202410417973.9

(51) Int. Cl. G06T 11/10

(52) U.S. Cl. CPC G06T 11/10; G06T 2200/24

(57) ABSTRACT

A display method performed by an electronic device includes displaying, in a navigation map interface, a navigation object and at least one map object in a first style and including a target map object, and displaying, in response to the target map object being located in a target area set around the navigation object, a process of the target map object changing from the first style to a second style. A first information amount of the target map object in the first style is greater than a second information amount of the target map object in the second style.

### CROSS-REFERENCE TO RELATED APPLICATIONS

This disclosure is a continuation of International Application No. PCT/CN 2025/082961, filed on Mar. 17, 2025, which is based on and claims priority to Chinese Patent Application No. 2024104179739, filed on Apr. 8, 2024, the entire contents of both of which are incorporated herein by reference.

### FIELD OF THE TECHNOLOGY

This disclosure relates to the technical field of the Internet, and in particular, to a display method and apparatus for navigation information, an electronic device, a computer-readable storage medium, and a computer program product.

### BACKGROUND OF THE DISCLOSURE

With the rapid development of computer technologies and communication technologies, route navigation has been widely applied to daily travel of people. Generally, route navigation mainly refers to calculating a navigation route according to a start point and an end point that are set by a user, and guiding the user to drive to the end point according to the navigation route.

In related art, map objects (such as structures including buildings and trees) around a route need to be displayed in a navigation map interface. To make display of the map objects more realistic, the map objects are often displayed with complex details, which greatly affects information such as roads and intersections in the navigation route, resulting in low recognizability of effective navigation information for users and poor navigation effects.

### SUMMARY

In accordance with the disclosure, there is provided a display method performed by an electronic device and including displaying, in a navigation map interface, a navigation object and at least one map object in a first style and including a target map object, and displaying, in response to the target map object being located in a target area set around the navigation object, a process of the target map object changing from the first style to a second style. A first information amount of the target map object in the first style is greater than a second information amount of the target map object in the second style.

Also in accordance with the disclosure, there is provided an electronic device including a memory storing computer-executable instructions, and a processor configured to execute the computer-executable instructions to display, in a navigation map interface, a navigation object and at least one map object in a first style and including a target map object, and display, in response to the target map object being located in a target area set around the navigation object, a process of the target map object changing from the first style to a second style. A first information amount of the target map object in the first style is greater than a second information amount of the target map object in the second style.

Also in accordance with the disclosure, there is provided a non-transitory computer-readable storage medium storing computer-executable instructions that, when executed by a processor, cause an electronic device including the processor to display, in a navigation map interface, a navigation object and at least one map object in a first style and including a target map object, and display, in response to the target map object being located in a target area set around the navigation object, a process of the target map object changing from the first style to a second style. A first information amount of the target map object in the first style is greater than a second information amount of the target map object in the second style.

### BRIEF DESCRIPTION OF THE DRAWINGS

FIG. 1 is a schematic architectural diagram of a navigation information display system provided by an embodiment of this disclosure.

FIG. 2 is a schematic structural diagram of an electronic device provided by an embodiment of this disclosure.

FIG. 3 is a first schematic flowchart of a display method for navigation information provided by an embodiment of this disclosure.

FIG. 4 is a first schematic diagram showing a navigation map interface provided by an embodiment of this disclosure.

FIG. 5 is a second schematic diagram showing a navigation map interface provided by an embodiment of this disclosure.

FIG. 6 is a third schematic diagram showing a navigation map interface provided by an embodiment of this disclosure.

FIG. 7 is a schematic diagram showing a change of a map object model of a target map object provided by an embodiment of this disclosure.

FIG. 8 is a cross-sectional schematic diagram showing a navigation map interface provided by an embodiment of this disclosure.

FIG. 9 is a fourth schematic diagram showing a navigation map interface provided by an embodiment of this disclosure.

FIG. 10 is a second schematic flowchart of a display method for navigation information provided by an embodiment of this disclosure.

FIG. 11 is a third schematic flowchart of a display method for navigation information provided by an embodiment of this disclosure.

FIG. 12A is a first schematic structural diagram of a map object provided by an embodiment of this disclosure.

FIG. 12B is a second schematic structural diagram of a map object provided by an embodiment of this disclosure.

The foregoing “first” and “second” are merely used to distinguish different solutions, and do not represent superiority or inferiority of the solutions or priority in an implementation process.

### DESCRIPTION OF EMBODIMENTS

To make objectives, technical solutions, and advantages of this disclosure clearer, the following describes this disclosure in further detail with reference to the accompanying drawings. The described embodiments are not to be considered as a limitation to this disclosure. All other embodiments obtained by a person skilled in the art without creative efforts fall within the scope of this disclosure.

In the following description, “some embodiments” are involved, and a subset of all possible embodiments is described. However, “some embodiments” may be the same subset or different subsets of all the possible embodiments, and may be combined with each other without conflict.

In the following description, the terms “first,” “second,” and “third” involved are merely intended to distinguish similar objects, and do not represent a specific ordering of objects. “First,” “second,” and “third” may, where permissible, be interchanged in their specific order or sequence, so that the embodiments of this disclosure described herein may be implemented in an order other than those illustrated or described herein.

In the embodiment of this disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. Furthermore, the module or unit may be a part of an integrated module or unit that includes the functionality of the module or unit.

Unless otherwise defined, all technical and scientific terms used in the embodiments of this disclosure have the same meanings as those commonly understood by a person skilled in the art. Terms used in the embodiments of this disclosure are only intended to describe the embodiments of this disclosure, and are not intended to limit this disclosure.

During example application of relevant data collection and processing in this disclosure, the informed consent or individual consent of a personal information subject needs to be obtained in strict accordance with requirements of relevant laws and regulations, and the subsequent data use and processing behavior is carried out within an authorized scope of laws and regulations and the personal information subject.

Before the embodiments of this disclosure are further described in detail, nouns and terms involved in the embodiments of this disclosure are described. The nouns and terms involved in the embodiments of this disclosure are applied to the following explanations.
1) Client: an application run on an electronic device to provide various services, for example, a client supporting navigation.
2) Being in response to: representing a condition or a state on which an executed operation depends. When the dependent condition or state is satisfied, one or more executed operations may be in real-time or have a set delay. Unless otherwise specified, there is no limitation on an execution order of the plurality of executed operations.

Embodiments of this disclosure provide a display method and apparatus for navigation information, an electronic device, a computer-readable storage medium, and a computer program product, capable of improving navigation information display effects and navigation effects. Next, based on the foregoing descriptions of the nouns and terms involved in the embodiments of this disclosure, detailed descriptions of the embodiments of this disclosure are provided.

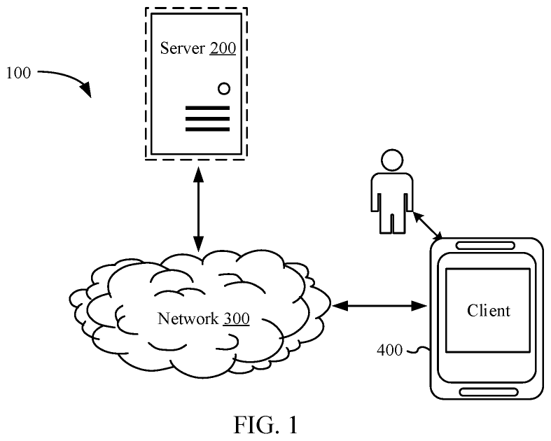

The following describes a navigation information display system provided by an embodiment of this disclosure. FIG. 1 is a schematic architectural diagram of a navigation information display system provided by an embodiment of this disclosure. To support an exemplary application, a navigation information display system 100 includes: a server 200, a network 300, and a terminal 400. The terminal 400 is connected to the server 200 through the network 300. The network 300 may be a wide area network, a local area network, or a combination thereof. Data transmission is implemented using a wireless or a wired link.

Here, the terminal 400 (for example, running a client supporting navigation) sends, in response to a navigation instruction for a navigation object, a navigation data acquisition request for the navigation object to the server 200. The server 200 receives the navigation data acquisition request for the navigation object, and, in response to the navigation data acquisition request, returns navigation data to the terminal 400. The terminal 400 receives the navigation data returned by the server 200, and, based on the navigation data, renders and displays a navigation map interface. In the navigation map interface, the navigation object and at least one map object in a first style are displayed. In response to a target map object being located in a target area set around the navigation object, a process of the target map object changing from the first style to a second style is displayed. The at least one map object includes the target map object, and an information amount of the target map object in the second style is less than an information amount of the target map object in the first style.

In some embodiments, a display method for navigation information provided by the embodiments of this disclosure may be implemented by an electronic device, for example, may be separately implemented by a terminal, or may be separately implemented by a server, or may be collaboratively implemented by a terminal and a server. The embodiments of this disclosure may be applied to various scenarios, including but not limited to cloud technology, artificial intelligence (AI), intelligent transportation, assisted driving, unmanned driving, autonomous driving, and the like.

In some embodiments, an electronic device for implementing the display method for navigation information provided by the embodiments of this disclosure may be various types of terminals or servers. The server (for example, the server 200) may be an independent physical server, or may be a server cluster including a plurality of physical servers or a distributed system. The terminal (for example, the terminal 400) may be, but is not limited to, a laptop computer, a tablet computer, a desktop computer, a smartphone, a smart voice interaction device (for example, a smart speaker), a smart appliance (for example, a smart television), a smart watch, a vehicle-mounted terminal, a wearable device, a virtual reality (VR) device, an aircraft, or the like. The terminal and the server may be directly or indirectly connected in a wired or wireless communication mode. This is not limited in the embodiments of this disclosure.

In some embodiments, the display method for navigation information provided by the embodiments of this disclosure may be implemented by using a cloud technology. The cloud technology refers to a hosting technology that unifies a series of resources such as hardware, software, and networks in a wide area network or a local area network to implement computing, storage, processing, and sharing of data. The cloud technology is a collective name for a network technology, an information technology, an integration technology, a platform management technology, an application technology, and the like based on an application of a cloud computing business mode. It may form a resource pool for on-demand use, providing flexibility and convenience. A cloud computing technology becomes an important support. A background service of a technical network system requires a large amount of computing resources and storage resources. In an example, the server (for example, the server 200) may alternatively be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

In some embodiments, the display method for navigation information provided by the embodiments of this disclosure may be implemented by using an artificial intelligence technology. Artificial intelligence is a comprehensive technology of computer science, which is to study design principles and implementation methods of various intelligent machines, to enable machines to have the functions of perception, reasoning, and decision-making. The basic artificial intelligence technologies generally include technologies such as a sensor, a dedicated artificial intelligence chip, cloud computing, distributed storage, a big data processing technology, a pre-trained model technology, an operating/interactive system, and electromechanical integration. A pre-trained model, also known as a large model or a foundation model, may be widely applied to downstream tasks in various directions of artificial intelligence after fine-tuning. Artificial intelligence software technologies mainly include several major directions, such as a computer vision technology, a speech processing technology, a natural language processing technology, and machine learning/deep learning. As an example, a navigation route displayed in the navigation map interface provided by the embodiments of this disclosure may be obtained based on the artificial intelligence technology. In practical applications, there may be a plurality of navigation routes from a start position to an end position of the navigation object. In this case, a target navigation route satisfying conditions (for example, shortest time and least time consumption) may be selected from the plurality of navigation routes based on a pre-trained machine learning model to be provided to a user.

In some embodiments, the terminal or the server may implement the display method for navigation information provided by the embodiments of this disclosure by running various computer-executable instructions or computer programs. For example, the computer-executable instruction may be a microprogram-level command, a machine instruction, or a software instruction. The computer program may be a native program or a software module in an operating system; may be a native application (APP), i.e., a program that needs to be installed in the operating system for running, for example, a navigation APP; or may be a mini program that may be embedded into any APP, i.e., a program that only needs to be downloaded to a browser environment to run. In summary, the foregoing computer-executable instructions may be instructions in any form, and the foregoing computer program may be an application, a module, or a plug-in in any form.

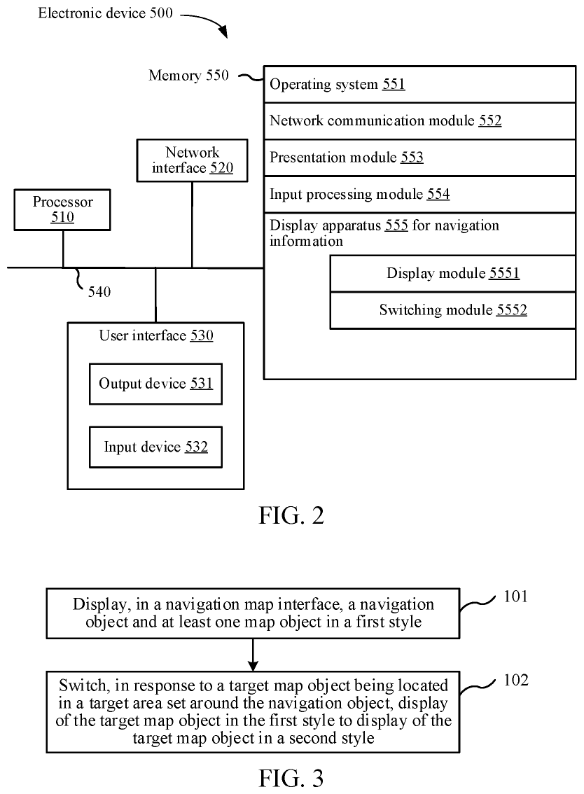

The following describes the electronic device provided by the embodiments of this disclosure for implementing the display method for navigation information. FIG. 2 is a schematic structural diagram of an electronic device provided by an embodiment of this disclosure. An electronic device 500 provided by the embodiment of this disclosure may be a terminal, or may be a server. As shown in FIG. 2, the electronic device 500 includes: at least one processor 510, a memory 550, at least one network interface 520, and a user interface 530. All components in the electronic device 500 are coupled together by using a bus system 540. The bus system 540 is configured to implement connection and communication among these components. In addition to a data bus, the bus system 540 further includes a power bus, a control bus, and a state signal bus. However, for ease of clear description, all types of buses are marked as the bus system 540 in FIG. 2.

The processor 510 may be an integrated circuit chip having a signal processing capability, for example, a general-purpose processor, a digital signal processor (DSP), or another programmable logic device, a discrete gate, or a transistor logical device, or a discrete hardware component. The general-purpose processor may be a microprocessor, any suitable processor, or the like.

The user interface 530 includes one or more output devices 531 that enable the presentation of media content, including one or more speakers and/or one or more visual display screens. The user interface 530 further includes one or more input devices 532, including a user interface component facilitating the input of the user, such as a keyboard, a mouse, a microphone, a touch display screen, a camera, an input button, or a control.

The memory 550 may be removable, non-removable, or a combination thereof. The memory 550 may include one or more storage devices away from the processor 510 in a physical position. The memory 550 includes a volatile memory or a non-volatile memory, or may include both a volatile memory and a non-volatile memory. The non-volatile memory may be a read only memory (ROM). The volatile memory may be a random access memory (RAM). The memory 550 described in the embodiment of this disclosure is intended to include any suitable type of memory.

In some embodiments, the memory 550 may store data to support various operations. An example of these data includes a program, a module, and a data structure or a subset or a superset thereof, which may be exemplarily described below.

An operating system 551 includes system programs for processing various basic system services and executing hardware-related tasks, for example, a frame layer, a core library layer, and a drive layer, and is configured to implement various basic services and process hardware-based tasks.

A network communication module 552 is configured to reach another electronic device via one or more (wired or wireless) network interfaces 520. Exemplary network interfaces 520 include: Bluetooth, wireless compatible authentication (WiFi), a universal serial bus (USB), and the like.

A presentation module 553 is configured to enable presentation of information via one or more output devices 531 (for example, a display screen and a speaker) associated with the user interface 530 (for example, a user interface configured to operate a peripheral device and display content and information).

An input processing module 554 is configured to detect one or more user inputs or interactions from one of one or more input devices 532 and translate the detected inputs or interactions.

In some embodiments, a display apparatus for navigation information provided by the embodiments of this disclosure may be implemented in a software mode. FIG. 2 shows a display apparatus 555 for navigation information stored in the memory 550. The display apparatus 555 for navigation information may be software in a form of a program, a plug-in, or the like, including the following software modules: a display module 5551 and a switching module 5552. These modules are logical. Therefore, they may be arbitrarily combined or further subdivided according to functions to be implemented, and the functions of respective modules will be described below.

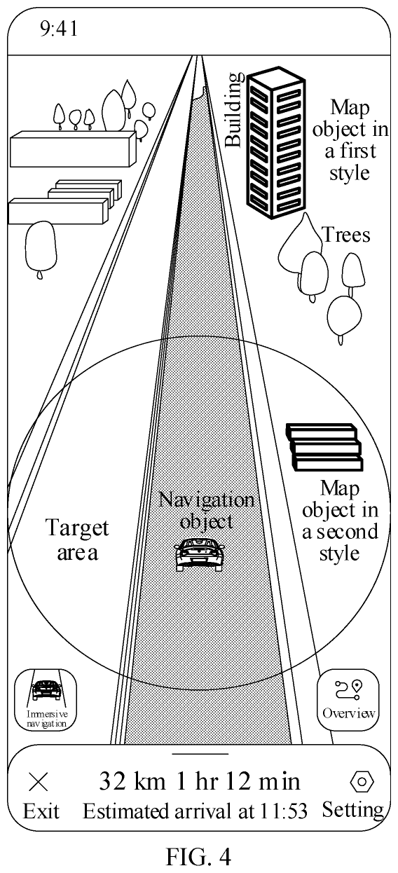

The following describes the display method for navigation information provided by the embodiments of this disclosure. As previously described, the display method for navigation information provided by the embodiments of this disclosure may be implemented by an electronic device, for example, may be separately implemented by a server or a terminal, or may be collaboratively implemented by a server and a terminal. Therefore, an execution body for each operation is not repeatedly described below. FIG. 3 is a schematic flowchart of a display method for navigation information provided by an embodiment of this disclosure. The display method for navigation information provided by the embodiment of this disclosure includes:
Operation 101: Display, in a navigation map interface, a navigation object and at least one map object in a first style.

In operation 101, the navigation map interface is configured for navigating the navigation object. The navigation map interface may display a navigation route, travel time, prompt information for navigation, and the like. While displaying the navigation map interface, corresponding prompts may alternatively be output in a mode of text, voice, or vibration in synchronization, thereby enhancing navigation capabilities in a plurality of dimensions and achieving effective reminders. In practical applications, the electronic device may be provided with a client supporting navigation, and a navigation map interface is displayed by running the client. The electronic device may be a terminal such as a smartphone or a tablet, or may be a vehicle-mounted terminal. In the embodiment of this disclosure, the navigation object is displayed in the navigation map interface, and the navigation object may be an object that needs to be navigated, such as a person or a vehicle. Meanwhile, in the navigation map interface, the at least one map object in the first style is also displayed, and specifically, an object model (for example, a three-dimensional model) of the map object in the first style may be displayed. The first style may be preset, and the map object may be an object corresponding to a ground feature in the real world that needs to be drawn in the navigation map. The map object may be a structure such as a building, a bridge, a park, or a factory, or may be an object such as a tree or greenery, and this is not limited herein.

In some embodiments, in the navigation map interface, the navigation object and the at least one map object in the first style may be displayed in the following manner: displaying a navigation road in the navigation map interface; displaying the navigation object on the navigation road; and displaying, on a periphery of the navigation road, at least one of the map objects in the first style. Here, the navigation road is displayed in the navigation map interface. Based on this, the navigation object may be displayed on the navigation road, that is, the navigation object is displayed at a position where the navigation object is located in the navigation road; and at least one of the map objects may be displayed in the first style on the periphery of the navigation road.

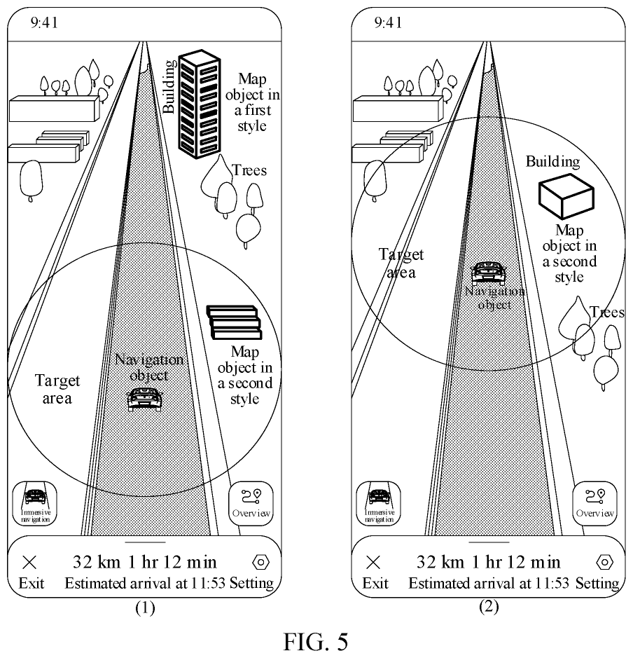

As an example, FIG. 4 is a first schematic diagram showing a navigation map interface provided by an embodiment of this disclosure. Here, a navigation road is displayed in the navigation interface, and a navigation object, that is, a vehicle, is displayed on the navigation road. On a periphery of the navigation road, a map object in a first style is displayed, including buildings and trees.

According to the embodiments of this disclosure, navigation clarity may be improved, cognitive load may be reduced, driving safety may be improved, and interaction efficiency may be improved.

In some embodiments, the navigation object and the at least one map object in the first style may be displayed in the following manner: displaying the navigation object; and displaying, outside a target area set around the navigation object, at least one map object in the first style. Here, the at least one map object in the first style is displayed outside the target area set around the navigation object. The target area may be a circular area with the navigation object as a center and a target length as a radius, or may be a triangular area, a square area, a rectangular area, or various other shaped areas with the navigation object as a center.

As an example, with continued reference to FIG. 4, the target area is a circular area with the navigation object as a center and a target length as a radius, and the at least one map object is displayed in the first style outside the target area.

According to the embodiments of this disclosure, the display style of the map object is controlled by the target area, so that a map object far away from the navigation object is still displayed in the first style without causing interference to the navigation object, and the differentiated display mode may effectively save rendering resources.

In some embodiments, the following operation may be further performed: displaying, within the target area set around the navigation object, at least one other map object in a second style, the other map object being a map object other than the at least one map object. Here, for the target area set around the navigation object, the at least one other map object located within the target area is displayed in the second style. The other map object does not belong to the at least one map object described above. As an example, with continued reference to FIG. 4, the target area is a circular area with the navigation object as a center and a target length as a radius, and the at least one other map object is displayed in the second style within the target area.

According to the embodiments of this disclosure, for other map objects in the target area, displaying in the second style reduces an information amount of the navigation map interface, decreases interference of information of the other map objects with the navigation map interface, makes the navigation map interface more concise, facilitates a user to quickly identify effective information from the navigation map interface, and improves navigation information display effects and navigation effects. Moreover, occupation of display resources is reduced, and utilization efficiency of the display resources is improved.
Operation 102: Display, in response to a target map object being located in the target area set around the navigation object, a process of the target map object changing from the first style to the second style.

The at least one map object includes the target map object, and an information amount of the target map object in the second style is less than an information amount of the target map object in the first style.

The navigation object moves according to the navigation route provided in the navigation map interface. In operation 102, the target area is determined by using the navigation object as a center. For example, the target area may be a circular area with the navigation object as a center and a target length as a radius, or may be a triangular area, a square area, a rectangular area, or various other shaped areas with the navigation object as a center. During travel according to the navigation map interface, the navigation object displays, in response to the target map object being located in the target area set around the navigation object, the process of the target map object changing from the first style to the second style. Specifically, a process of the target map object switching from the first style to the second style is displayed, and the target map object is controlled to maintain the second style unchanged when in the target area.

The information amount of the target map object in the second style is less than the information amount of the target map object in the first style. A degree of detail (or an amount of detail) of the target map object in the second style is lower than a degree of detail (or an amount of detail) of the target map object in the first style. In some embodiments, the displayed target map objects may all be target map object models (for example, three-dimensional models) of the target map objects, that is, a degree of detail (i.e., an information amount) of a target map object displayed by a target map object model in the second style (or a real object corresponding to the target map object in the real world) is lower than a degree of detail (i.e., an information amount) of a target map object displayed by a target map object model in the first style (or a real object corresponding to the target map object in the real world).

In this way, when the target map object is located in the target area set around the navigation object, that is, when the target map object approaches the navigation object, by switching the target map object in the first style to the target map object in the second style, an information amount of the target map object displayed in the navigation map interface is reduced, interference of the target map object with the navigation map interface is decreased, the navigation map interface is made more concise, a user is facilitated to view navigation conditions nearby from the navigation map interface, and navigation effects are improved. Moreover, occupation of display resources is reduced, and utilization efficiency of the display resources is improved.

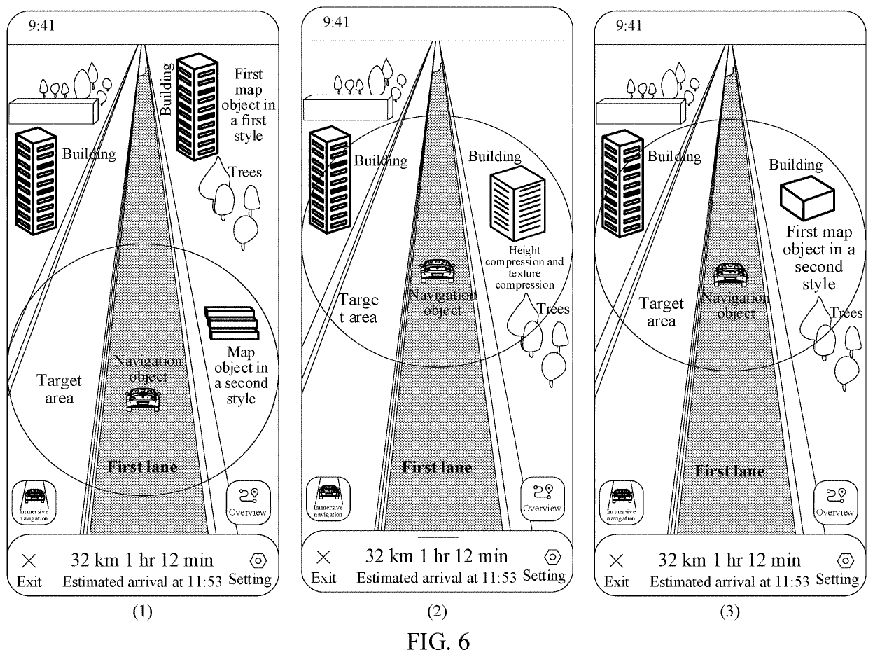

As an example, FIG. 5 is a second schematic diagram showing a navigation map interface provided by an embodiment of this disclosure. Here, a target map object in a first style is displayed on the navigation map interface, as shown in (1) of FIG. 5. In response to the target map object being located in a target area set around the navigation object, a process of the target map object changing from the first style to the second style is displayed, as shown in (2) of FIG. 5. A target map object model of the target map object shown in (1) of FIG. 5 includes pane lines and a lighting effect, and a height of the target map object model matches a real object corresponding to the target map object more closely. A target map object model of the target map object shown in (2) of FIG. 5 is merely a simple cubic model, and does not include the pane lines and the lighting effect. A height of the target map object model is lower than the height of the target map object model shown in (1) of FIG. 5. It can be seen that an information amount (a degree of detail) of the target map object in the second style is less than an information amount of the target map object in the first style.

In some embodiments, the navigation object is located in a first lane of a first road in the navigation map interface. A quantity of the target map objects is plural, and the plurality of target map objects are located on both sides of the first road. In operation 102, the displaying a process of the target map object changing from the first style to the second style may be implemented by the following technical solution: displaying, for a target map object closest to the first lane among the plurality of target map objects, a process of the closest target map object changing from the first style to the second style, in particular, determining a first map object from the plurality of target map objects, the first map object being closer to the first lane than a second map object, and the second map object being a map object different from the first map object among the target map objects; and switching display of the first map object in the first style to display of the first map object in the second style.

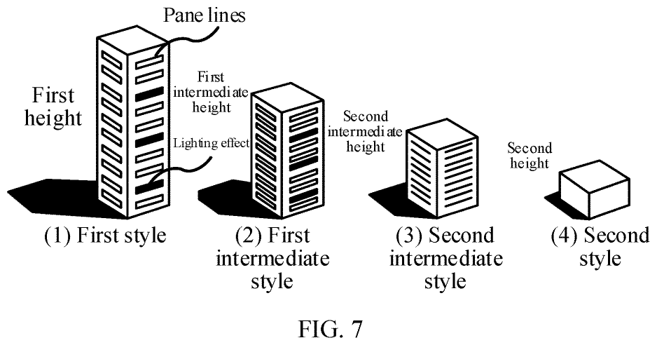

Here, the navigation object is located in the first lane of the first road in the navigation map interface, and the plurality of target map objects are located on both sides of the first road. As an example, FIG. 6 is a third schematic diagram showing a navigation map interface provided by an embodiment of this disclosure. Here, as shown in (1) of FIG. 6, a navigation object is located in a first lane of a first road in the navigation map interface, and a plurality of target map objects located in a target area are distributed on both sides of the first road. Based on this, when switching a display style of the target map object, a first map object may be determined from the plurality of target map objects. Here, the first map object is closer to the first lane than a second map object. The second map object is a map object different from the first map object among the target map objects. In this way, only display of the first map object in the first style may be switched to display of the first map object in the second style. In this way, occupation of device resources by processing for switching the display styles of the target map objects is reduced, a speed of switching the display style of the target map object is improved, and utilization efficiency of the device resources is also improved. With continued reference to FIG. 6, as shown in (2) and (3) of FIG. 6, the first map object is a target map object distributed on a side closer to the first lane. A height of the first map object is compressed, and with the compression of the height of the first map object, a texture of the first map object is compressed, and the texture gradually disappears, to obtain the first map object in the second style. Therefore, the first map object is displayed only in the second style, while the second map object is still displayed in the first style and remains unchanged.

In some embodiments, a quantity of the target map objects is plural. Based on this, in operation 102, the displaying a process of the target map object changing from the first style to the second style may be implemented by the following technical solution: displaying, for the target map object, when an information amount of the target map object in the first style reaches an information amount threshold of the target map object, the process of the target map object changing from the first style to the second style. Specifically, for the target map object, when the information amount of the target map object in the first style reaches the information amount threshold of the target map object, the target map object is determined as a third map object. Display of the third map object in the first style is switched to display of the third map object in the second style.

Here, a degree of detail of the target map object in the first style displayed in the navigation map interface may not be high. Therefore, the following processing may be performed for the target map objects, respectively: determining whether the information amount of the target map object in the first style reaches the information amount threshold of the target map object. The information amount threshold of the target map object is set for the target map object, and information amount thresholds of different target map objects may be the same or may be different. When it is determined that the information amount of the target map object in the first style reaches the information amount threshold of the target map object, the target map object is determined as the third map object. Continuously, only display of the third map object in the first style is switched to display of the third map object in the second style. In this way, occupation of device resources by processing for switching the display styles of the target map objects is reduced, a speed of switching the display style of the target map object is improved, and utilization efficiency of the device resources is also improved.

In some embodiments, a quantity of the target map objects is plural. Based on this, in operation 102, the displaying a process of the target map object changing from the first style to the second style may be implemented by the following technical solution: displaying, for the target map object, when the target map object is located at a target position, the process of the target map object changing from the first style to the second style. Specifically, a fourth map object located at a target position is determined from the plurality of target map objects. Display of the fourth map object in the first style is switched to display of the fourth map object in the second style.

Here, the fourth map object located at the target position may alternatively be determined from the plurality of target map objects. The target position may be preset, and the target position may be a position at an intersection, a turning intersection, a crossroad, a fork, a complex road segment, or the like. The target location may be determined based on prediction by a machine learning model. For example, the machine learning model may be trained based on information such as road structures (for example, intersections, turning intersections, crossroads, forks, and complex road segments included in roads) and travel conditions of a user on the roads (for example, intersections or roads where the user often makes wrong turns). Thus, based on the trained machine learning model, the target position is predicted based on information such as existing road structures and travel conditions of the user on roads, to obtain the target position. Continuously, only display of the fourth map object in the first style is switched to display of the fourth map object in the second style. In this way, occupation of device resources by processing for switching the display styles of the target map objects is reduced, a speed of switching the display style of the target map object is improved, and utilization efficiency of the device resources is also improved.

In some embodiments, the target map object in the first style is a target map object with a first height, and the target map object in the second style is a target map object with a second height. In operation 102, the displaying a process of the target map object changing from the first style to the second style may be implemented by the following technical solution: displaying a process of the target map object changing from the first height to the second height, the second height being lower than the first height.

As an example, display of the target map object at the first height is switched to display of the target map object at the second height, to switch display of the target map object in the first style to display of the target map object in the second style.

Here, by switching from display of the target map object at the first height to display of the target map object at the second height, the process of the target map object changing from the first style to the second style is displayed. The second height is lower than the first height.

According to the embodiments of this disclosure, adjusting the height of the target map object from the first height to the second height is equivalent to avoiding visual obstruction of a navigation process caused by the target map object, so that a driver is not affected by irrelevant target map objects when following the navigation object to view a navigation route while viewing a navigation interface, thereby both saving resource consumption and adapting to user requirements.

In some embodiments, when switching the target map object with the first height to the target map object with the second height, it may be determined whether the first height is higher than a height threshold. When the first height is higher than the height threshold, display of the target map object at the first height is switched to display of the target map object at the second height. If the first height is not higher than the height threshold, the first height of the target map object is maintained unchanged, and the process of the target map object changing from the first style to the second style is displayed from an aspect different from a height aspect (for example, a texture aspect).

According to the embodiments of this disclosure, based on a hierarchical control optimization concept, a display strategy is dynamically adjusted according to the height threshold, so that unnecessary computation may be avoided and rendering efficiency may be improved. Then, multi-dimensional perception enhancement is achieved. Through dual adjustment of height and other aspects, map objects that may affect a user are displayed in a differentiated manner from multiple dimensions, so that the user is not disturbed during navigation, and navigation requirements of the user may be satisfied.

In some embodiments, the switching from display of the target map object at the first height to display of the target map object at the second height may be performed in the following manner: displaying, based on a height variation parameter, a process of a map object model of the target map object changing from the first height to the second height.

Here, when switching from display of the target map object at the first height to display of the target map object at the second height, the process of the map object model of the target map object changing from the first height to the second height based on the height variation parameter may be displayed, that is, a process of compressing from the first height to the second height. The height variation parameter may be preset. For example, the height variation parameter may be a height variation speed, such as a target percentage or a target height of compressing the first height per second, or the height variation parameter may be height variation indication information, such as a target percentage or a target height of compressing the first height every time the navigation object travels a first distance.

According to this embodiment of this disclosure, the displaying, based on a height variation parameter, a process of a map object model of the target map object changing from the first height to the second height is actually performing adaptive rendering. Here, the map object model is gradually compressed, so that a load reduction of an image processor may be achieved.

In some embodiments, in the process of changing from the first height to the second height, the following operation may be further performed: performing, based on a change in height of the map object model, a physical simulation on a change of model texture of the map object model, and displaying a physically simulated change process of the model texture.

Here, in the process of the target map object changing from the first height to the second height, physical simulation may further be performed on the change of the model texture of the map object model based on the change in height of the map object model, and the physically simulated change process of the model texture is displayed. In practical applications, physical simulation may be performed on the change of the model texture (for example, a height map texture and a normal map texture) of the map object model based on a physically based texture deformation (PBTD) algorithm. For example, PBTD is a technology for three-dimensional modeling and rendering. It simulates changes of texture on a surface of a map object model along with physical deformation. Transformation of the texture is driven based on a height change of the map object model by using physical laws, so that adaptive changes of the texture on the surface of the map object model look more natural and real. For example, implementing PBTD usually involves the following key operations: 1. Establish a texture coordinate system: First, a texture coordinate system needs to be established on a three-dimensional model (that is, the map object model), and this system may map a model surface to a two-dimensional texture space. Texture coordinates are usually associated with vertices of the model. 2. Define physical parameters: To make texture changes conform to the physical laws, some physical parameters affecting texture deformation need to be defined, such as elasticity, viscosity, and surface tension. These parameters will determine a response of the texture when subjected to external forces. 3. Simulate texture deformation: Texture changes caused by model deformation are simulated through numerical methods (such as finite element analysis). This usually involves solving partial differential equations (PDEs), such as elastic equations or viscoelastic equations. 4. Apply boundary conditions: Appropriate boundary conditions need to be applied during the simulation process to ensure rationality of texture deformation. For example, for a building, factors such as windows and lights of the building may need to be considered. 5. Optimize and iterate: A sense of realism of texture deformation is improved through an iterative optimization process. This may include adjusting a physical parameter, optimizing a numerical simulation algorithm, and the like. 6. Integrate into a rendering process: Finally, the deformed texture is integrated into the rendering process to ensure that the texture deformation still appears natural under different lighting and viewing angle conditions.

In some embodiments, in the process of changing from the first height to the second height, the following operation may be further performed: controlling, based on a change in height of the map object model, a model transparency of the map object model to change, and displaying a changing process of the model transparency.

Here, in the process of the target map object changing from the first height to the second height, the model transparency of the map object model may further be changed based on the change in height of the map object model, and the changing process of the model transparency is displayed. The change of the model transparency may be implemented based on a preset transparency variation parameter. For example, the transparency variation parameter may be a transparency variation speed, and the transparency variation parameter may alternatively be a mapping relationship between the height and the transparency. That is, when the height changes, the transparency is calculated based on the changed height, thereby changing the transparency.

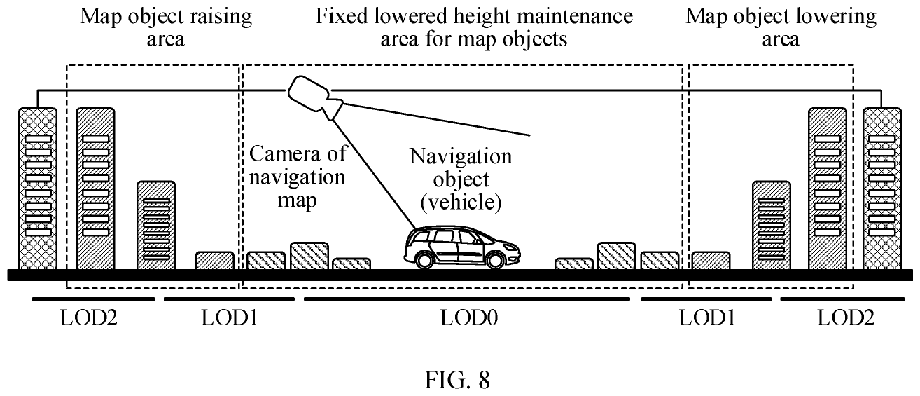

As an example, FIG. 7 is a schematic diagram showing a change of a map object model of a target map object provided by an embodiment of this disclosure. Here, as shown in (1) of FIG. 7 to (4) of FIG. 7, the map object model is compressed from a first height to a second height, specifically, the first height-a first intermediate height-a second intermediate height-the second height, and physical simulation is also performed on a change of a model texture of the map object model based on a change in height of the map object model. The model texture of the map object model also changes. As can be seen from (1) of FIG. 7 to (4) of FIG. 7, a height map texture of the map object model changes, a normal map texture changes, and pane lines and lighting effects of the map object model gradually disappear. That is, in a process of compressing from the first height to the second height, along with compression of the height of the map object model, texture (including a normal map texture, a height map texture, and textures of pane lines and lighting effects) of the map object model is also compressed, and gradually disappears.

Through the change process provided by the embodiment of this disclosure, visual interference may be reduced; dynamic adjustment of transparency may lower rendering load; and the transparency change may avoid affecting attention of a user, help guide the user to focus on important information, or reduce interference of secondary information, thereby improving human-machine interaction efficiency.

In some embodiments, a process of changing the target map object from a first style to a second style may be displayed in the following manner: switching display of the target map object in the first style to display of the target map object in the second style; or displaying a style switching process in which the target map object switches from the first style, through at least one intermediate style, to the second style, an information amount of the target map object in the intermediate style being less than an information amount of the target map object in the first style, and the information amount of the target map object in the intermediate style being greater than an information amount of the target map object in the second style, and the information amount of the target map object in the intermediate style being positively correlated with a distance between the target map object in the intermediate style and the navigation object. Specifically, when a quantity of the intermediate styles is plural, an information amount of a target map object in a target intermediate style passed through in the style switching process is greater than an information amount of a target map object in a next intermediate style following the target intermediate style passed through, where the plurality of intermediate styles include the target intermediate style.

Here, in a process of switching the target map object from the first style to the second style, at least one intermediate style is passed through. The information amount of the target map object in the intermediate style is less than the information amount of the target map object in the first style, and the information amount of the target map object in the intermediate style is greater than the information amount of the target map object in the second style. However, when a quantity of the intermediate styles is plural, an information amount of the target map object in the target intermediate style passed through in the style switching process is greater than the information amount of the target map object in the next intermediate style following the target intermediate style passed through. That is, for the plurality of intermediate styles passed through, information amounts decrease sequentially. As an example, with continued reference to FIG. 7, in FIG. 7, the first style is switched to the second style, and a first intermediate style and a second intermediate style are passed through. A degree of detail of the first intermediate style is lower than a degree of detail of the first style, a degree of detail of the second intermediate style is lower than the degree of detail of the first intermediate style, and a degree of detail of the second style is lower than the degree of detail of the second intermediate style. In this way, a style switching effect of the target map object may be improved. A transition process exists in the switching process, so that a display effect of a navigation map interface is higher, thereby improving navigation effects for a user.

In some embodiments, in response to the target map object being located in a target area set around the navigation object, a process of the target map object changing from the first style to the second style may be displayed in the following manner: determining, in response to the target map object being located in the target area set around the navigation object, a projection size of the target map object in screen space; determining, based on the projection size, a target level of detail corresponding to the target map object; and displaying the process of the target map object changing from the first style to the second style corresponding to the target level of detail. For example, display of the target map object in the first style is switched to display of the target map object in the second style corresponding to the target level of detail.

Here, when performing display style switching for the target map object, the projection size of the target map object in screen space is first determined. The projection size actually refers to a pixel count of pixels occupied by the target map object on a screen. Then, the target level of detail corresponding to the target map object is determined based on the projection size. Here, the level of detail refers to a level of detail of a map object model of the map object. A higher level of detail indicates more details in the map object model. The level of detail is preset and classified, for example, level of detail 1, level of detail 2, level of detail 3, level of detail 4. When determining the target level of detail corresponding to the target map object based on the projection size, the target level of detail corresponding to the target map object having the projection size may be determined according to a preset mapping relationship; and display of the target map object in the first style is then switched to display of the target map object in the second style corresponding to the target level of detail.

For example, the level of detail in the embodiment of this disclosure may be determined based on a level of detail (LOD) technology. The LOD technology refers to a technology in three-dimensional (3D) computer graphics design for dynamically adjusting model details (such as map object model details) based on a distance and an angle of an observer, capable of optimizing performance, reducing rendering costs, and maintaining sufficient visual quality. For example, the LOD technique may include: 1. Create map object models of a plurality of levels of detail: Designers create a plurality of versions for each map object, each version having a different detail level. These versions may be textures of different resolutions, simplified geometric structures, or models with lower polygon counts. 2. Define LOD switching conditions: Developers define when and how to switch between different LOD levels. This usually depends on a distance between an observer and an object, but other factors such as a field of view angle and frustum culling may alternatively be considered. 3. Implement an LOD switching algorithm: At runtime, a client supporting navigation may use preset conditions (for example, at which position in the target area the target map object is located) to determine which LOD level of model to use. This usually involves calculating the distance between the observer and the object, and comparing the distance with a preset threshold. 4. Optimize performance: The LOD technology may significantly improve rendering performance, because it may reduce a number of triangles that need to be rendered per frame, thereby reducing loads on a central processing unit (CPU) and a graphics processing unit (GPU). For example, the levels of detail may be classified into level of detail 0, level of detail 1, level of detail 2, level of detail 3, and level of detail 4. As the level of detail increases, the detail level also increases.

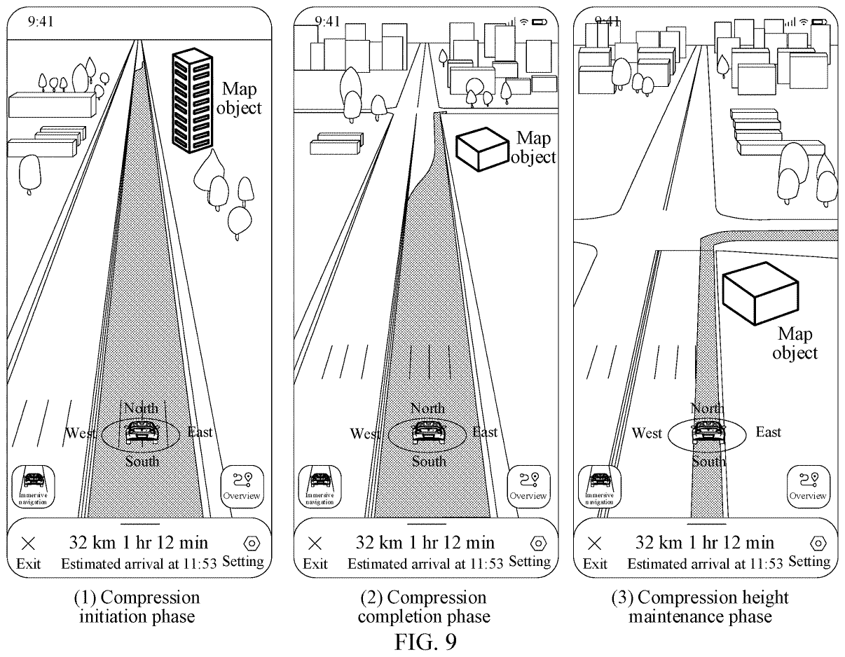

As an example, FIG. 8 is a cross-sectional schematic diagram showing a navigation map interface provided by an embodiment of this disclosure. Here, map object models of three levels of detail (including LOD0, LOD1, and LOD2) are displayed in total. During travel of a navigation object (i.e., a vehicle), a target map object is displayed in a style of LOD0 level within a target area of the vehicle, and other map objects different from the target map object are displayed in a style different from the LOD0 level after the target area of the vehicle.

According to the embodiment of this disclosure, performance may be optimized based on the level of detail, rendering costs may be reduced, and sufficient visual quality may be maintained.

In some embodiments, the following operations may be further performed: displaying a style switching enable control; and enabling, in response to an enable instruction for the style switching enable control, a style switching mode for the map object. Based on this, in response to the target map object being located in the target area set around the navigation object, a process of the target map object changing from the first style to the second style may be displayed in the following manner: displaying, when the style switching mode is enabled, in response to the target map object being located in the target area set around the navigation object, the process of the target map object changing from the first style to the second style. For example, display of the target map object in the first style is switched to display of the target map object in the second style.

Here, a style switching enable control may be provided, and the style switching enable control is configured to enable the style switching mode for the map object. When the enable instruction for the style switching enable control is received, the style switching mode for the map object is enabled. Based on this, when the style switching mode is enabled, in response to the target map object being located in the target area set around the navigation object, the process of the target map object changing from the first style to the second style is displayed. In this way, an opportunity for selection may be provided to a user, and the user may select whether to enable the style switching mode according to needs, thereby improving a navigation use experience of the user and enhancing human-machine interaction efficiency.

In some embodiments, after the displaying a process of the target map object changing from the first style to the second style, the following operations may be further performed: displaying a style restoration control; and displaying, in response to a triggering operation for the style restoration control, a process of the target map object changing from the second style to the first style. For example, display of the target map object in the second style is switched to display of the target map object in the first style.

Here, a style restoration control may further be provided, and the style restoration control is configured to switch display of the target map object in the second style to display of the target map object in the first style when the triggering operation for the style restoration control is received. In this way, after the displaying a process of the target map object changing from the first style to the second style, the user may, according to needs, switch display of the target map object in the second style to display of the target map object in the first style through the style restoration control, for example, by triggering the triggering operation for the style restoration control (including but not limited to clicking, double-clicking, long-pressing, and the like). In this way, more degrees of freedom are given to the user, thereby improving a navigation use experience of the user and enhancing human-machine interaction efficiency.

In some embodiments, after the displaying a process of the target map object changing from the first style to the second style, the following operation may be further performed: displaying, in response to a target map object being located outside a target area set around the navigation object, a process of the target map object changing from the second style to the first style. For example, display of the target map object in the second style is switched to display of the target map object in the first style.

Here, since the navigation object is in a traveling process, the target area set around the navigation object also changes following a position of the navigation object. Therefore, as the navigation object travels, the target map object leaves the target area, that is, the target map object is located outside the target area set around the navigation object. Then, in response to the target map object being located outside the target area set around the navigation object, display of the target map object in the second style is switched to display of the target map object in the first style.

According to the embodiments of this disclosure, during travel of the navigation object, as the target map object leaves the target area, since a focus of attention of the user follows the navigation object, the target map object no longer causes interference to the user. Thus, restoring display of the target map object to the first style may make an overall display effect of the navigation interface more complete, the foregoing human-machine interaction process forms a closed loop, and an optimized human-machine interaction experience is provided for the user.

In some embodiments, when switching display of the target map object in the second style to display of the target map object in the first style, a process of a map object model of the target map object changing from the second height to the first height based on a height variation parameter is displayed. Meanwhile, based on a change in height of the map object model, a physical simulation on a change of model texture of the map object model is performed, and a physically simulated change process of the model texture is displayed; and based on the change in height of the map object model, a model transparency of the map object model is controlled to change, and a changing process of the model transparency is displayed.

In some embodiments, when switching display of the target map object in the second style to display of the target map object in the first style, a target style switching process in which the target map object switches from the second style, through at least one intermediate style, to the first style is displayed. An information amount of the target map object in the intermediate style is less than an information amount of the target map object in the first style, and the information amount of the target map object in the intermediate style is greater than an information amount of the target map object in the second style. When a quantity of the intermediate styles is plural, an information amount of a target map object in a target intermediate style passed through in the target style switching process is less than an information amount of a target map object in a next intermediate style following the target intermediate style passed through, and the plurality of intermediate styles include the target intermediate style.

In some embodiments, before the displaying a process of the target map object changing from the first style to the second style, a number of traffic events occurring in a target map object area within a historical time period is acquired. The target map object area is an area with the target map object as a center and a first distance as a radius. An information amount that is less than an information amount of the first style and is negatively correlated with the number of traffic events is determined as an information amount of the second style.

As an example, operation 1: Data acquisition and preprocessing: Set a target map object as a high-rise building A; delimit a circular area with the high-rise building A as a center and a radius of 500 meters (a first distance); call a traffic event database; and extract traffic accident data occurring in this area within the past 30 days (including: 8 rear-end collisions, 15 vehicle breakdowns, and 3 road construction events). Operation 2: Traffic event quantity calculation: perform weighted statistics on historical traffic events: weight of accident-class events (rear-end collisions)=1.5, weight of breakdown-class events=1.0, weight of construction-class events=0.8; and calculate a total event value=8×1.5 +15×1.0 +3×0.8=29.4. Operation 3: Information amount parameter mapping: Establish an information amount calculation model: information amount of the second style=basic information amount×(1 event coefficient), event coefficient=min (total event value/threshold, 0.7), where the threshold is set to 40 (a configurable parameter); and substitute data: event coefficient=29.4/40=0.735 →take 0.7. If the basic information amount (the first style) is 100 units, then information amount of the second style=100 ×(1-0.7)=30 units.

According to the embodiments of this disclosure, different information amounts of the second style may be set for target map objects at different positions, so that based on hindrance effects of target map objects in different areas on a user following the navigation object, display may be performed in different second styles. This may both avoid hindrance effects on the user following the navigation object, and maintain a complete display of the navigation interface as much as possible.

In an example, the embodiment of this disclosure may be applied to a vehicle-mounted scenario. For example, during travel of a vehicle, a navigation map interface provided by the embodiment of this disclosure is displayed through a vehicle-mounted terminal of the vehicle to drive according to navigation. In the navigation map interface, the vehicle and at least one map object in a first style (such as structures including buildings) are displayed. In response to a target map object being located in a target area centered on the vehicle, a process of the target map object changing from the first style to a second style is displayed. The at least one map object includes the target map object, and an information amount of the target map object in the second style is less than an information amount of the target map object in the first style. In this way, when the target map object is located in the target area centered on the vehicle, that is, when the target map object approaches the vehicle, by switching the target map object in the first style to the target map object in the second style, an information amount of the target map object displayed in the navigation map interface is reduced, interference of the target map object with the navigation map interface is decreased, the navigation map interface is made more concise, a user is facilitated to view navigation conditions nearby from the navigation map interface, and navigation effects are improved. Moreover, occupation of display resources is reduced, and utilization efficiency of the display resources is improved.

By applying the foregoing embodiments of this disclosure, in a navigation map interface, a navigation object and at least one map object in a first style are displayed. When a target map object is located in a target area set around the navigation object, a process of the target map object changing from the first style to a second style is displayed, and an information amount of the target map object in the second style is less than an information amount of the target map object in the first style.

Here, when the target map object is located in the target area set around the navigation object, that is, when the target map object approaches the navigation object, the target map object in the first style is switched to the target map object in the second style. In this way, an information amount of the target map object displayed in the navigation map interface is reduced, interference of information of the target map object with the navigation map interface is decreased, the navigation map interface is made more concise, a user is facilitated to quickly identify effective information from the navigation map interface, and navigation information display effects and navigation effects are improved. Moreover, occupation of display resources is reduced, and utilization efficiency of the display resources is improved.

An exemplary application of the embodiments of this disclosure in a practical application scenario is described below. In lane-level navigation, map objects with full heights (such as building blocks) cause severe occlusion to a currently navigated road, significantly affecting route recognition and intersection element visibility, and impairing navigation effects. Based on this, an embodiment of this disclosure provides a display method for navigation information. In a navigation mode, a compression coefficient of an overall height of map objects is first adjusted to a target value (such as 0.5). As a vehicle icon in the navigation map interface moves, after a map object gradually appears from a distance and maintains for a certain distance, starting from when the map object enters an animation area (that is, the foregoing target area), a height of the map object is compressed again according to a percentage under the target value until a minimum height, and when the map object is in the target area, the map object is maintained at the minimum height unchanged. Meanwhile, during compression of the height of the map object, textures such as normal panes of the map object and lighting effects of the map object are also compressed along with the compression of the height of the map object, and gradually disappear. In this way, display effects and performance consumption of the lane-level navigation may be optimized, especially significantly optimizing recognizability of 4K roads in the lane-level navigation. Meanwhile, lighting effects of map objects in a distance (non-target area) and an atmospheric feeling are not affected, and a navigation environment is also cleaner and more concise.

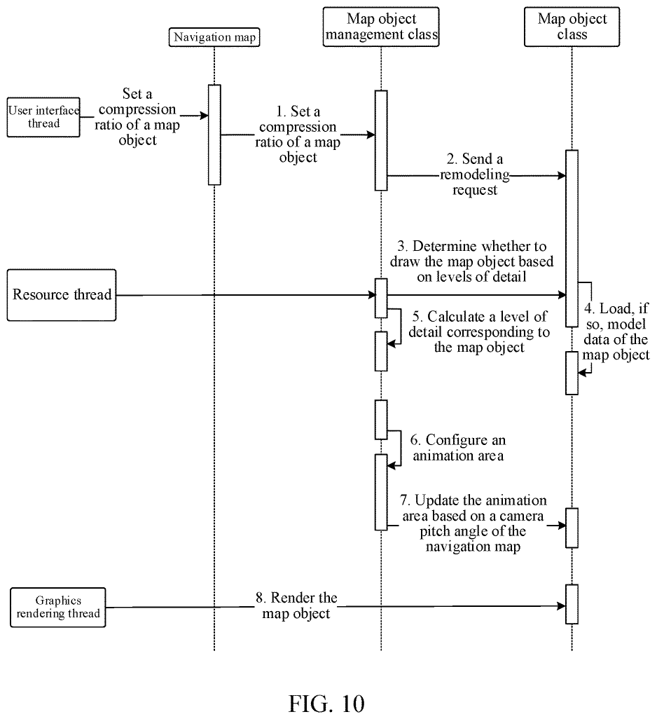

In some embodiments, the embodiment of this disclosure may be applied to a 3D navigation scenario for vehicle driving. As a self-vehicle icon moves forward, nearby map objects are lowered in height proportionally to reduce occlusion of nearby roads by the nearby map objects and optimize a user field of view. FIG. 9 is an interface used by a user in a 3D navigation map. As shown in (1) of FIG. 9, in a lane-level driving interface, as the self-vehicle icon moves forward, map objects are gradually compressed in height, and normal panes and lighting effects gradually fade and disappear. As shown in (2) of FIG. 9, distant map objects maintain their heights until entering a compression area. After entering the compression area, a lowering effect starts, and a compression animation is completed at a relatively long distance to reduce interference of map objects with an intersection surface. As shown in (3) of FIG. 9, the map objects are maintained at compressed heights.

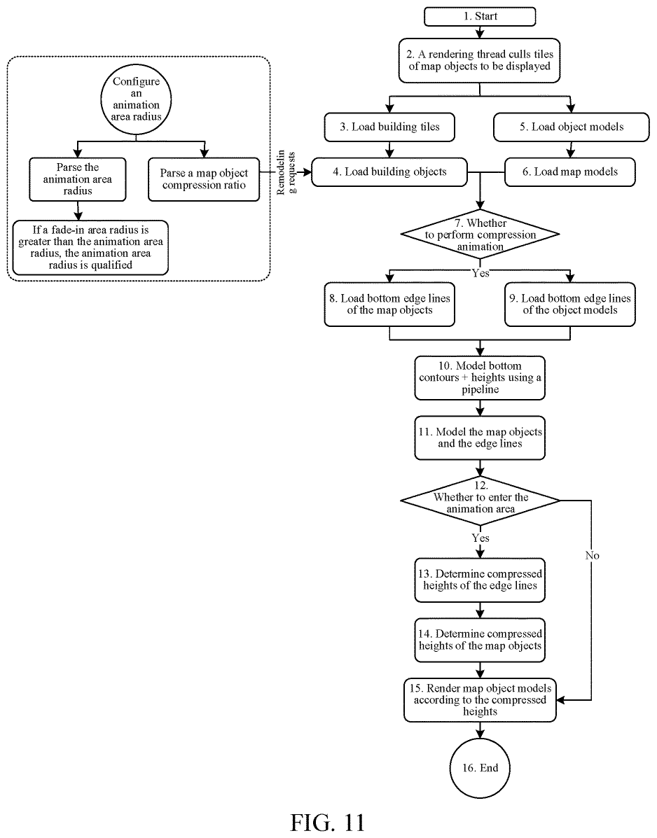

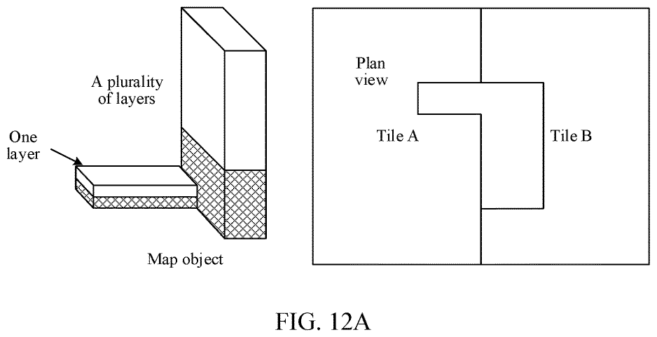

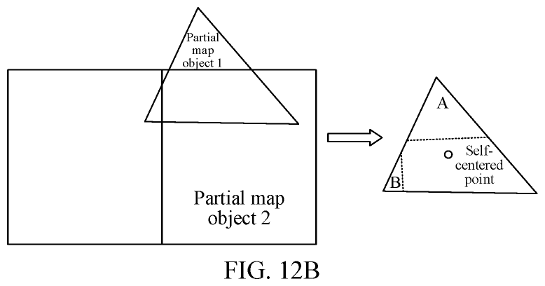

Referring to FIG. 8, what needs to be described in the embodiments of this disclosure includes:
1) For a compression animation of a map object requiring overall animation lowering of a combined map object, tile IDs of map objects within an animation range need to be collected in a SceneManager tool. An overall animation lowering effect for the combined map object is performed using an ID as a unique identifier.
2) An LOD level is calculated, and an animation area is configured according to the LOD level. The overall animation area is circular, heights of map objects entering the animation area are lowered, and heights of the map objects exiting the animation area are raised.
3) During a height compression process of the map object, based on a change in height, PBTD processing is performed on the normal panes, lighting textures, and the like. Physical simulation of texture changes for height map textures and normal map textures is performed to achieve effects where texture effects such as normal panes and lighting effects follow gradual lowering of the map object in height during the compression process, and the compression animation remains consistent with the height change of the map object.
4) During a compression process of the map object, a transparency channel also needs to be added to textures. While the textures are being lowered, transparency changes are maintained. The transparency is calculated by a vertex shader and passed to a fragment shader, and combined with a height lowering algorithm of the map object to calculate transparency frame-by-frame following height lowering of the map object.
5) An animation pace is controlled by a vehicle icon distance. When the vehicle icon moves, height rendering of the map object is performed. When the vehicle icon stops, rendering calculation is not required. In this way, GPU computation processing may be reduced, and GPU performance usage may be minimized.
6) Referring to FIG. 10, a timing flow of the embodiment of this disclosure includes: 1. Set a compression ratio of a map object. 2. Send a remodeling request. 3. Determine whether to draw the map object based on levels of detail. 4. Load, if yes, model data of the map object. 5. Calculate levels of detail corresponding to the map object. 6. Configure an animation area. 7. Update the animation area based on a camera pitch angle of the navigation map. 8. Render the map object.
7) Referring to FIG. 11, an animation area radius needs to be pre-configured. The animation area radius is parsed from configuration information, and a map object compression ratio is parsed. When a fade-in area radius is greater than the animation area radius, the animation area radius is determined to be qualified. Based on this, a flow of the embodiment of this disclosure includes: 1. Start. 2. A rendering thread culls tile IDs of map objects to be displayed. 3. Load building tiles. 4. Load building objects. 5. Load level-of-detail object models. 6. Load map models. 7. Whether to perform compression animation, and if so, execute 8 and 9. 8. Load bottom edge lines of the map objects. 9. Load bottom edge lines of the object models. 10. Model bottom contours+heights using a pipeline. 11. Model the map objects and the edge lines. 12. Whether to enter the animation area, and if so, execute 13. 13. Determine compressed heights of the edge lines. 14. Determine compressed heights of the map objects. 15. Render map object models according to the compressed heights. 16. End.
8) Compression analysis for complex map objects: 8.1) An animation of a combined map object needs to be entirely performed. Therefore, tile IDs of map objects within an animation area need to be collected in a SceneManager tool. An overall animation is performed using an ID as a unique identifier. 8.2) As shown in FIG. 12A, the combined map object has one layer or a plurality of layers. In effect, a height of a one-layer map object cannot be compressed downward further, and a lowest map object controls a guaranteed minimum height. 8.3) When splitting a combined map object, if a partial map object resulting from the splitting cannot use a common edge, a self-centered point may be set for the partial map object, as shown in FIG. 12B, so that individual compression is performed on the partial map object based on the self-centered point.

By applying the foregoing embodiments of this disclosure, display effects and performance consumption of lane-level navigation are optimized, occlusion and interference of the map objects with navigation road surfaces are reduced, and especially, recognizability of 4K roads in the lane-level navigation is significantly optimized. Meanwhile, lighting effects of map objects in a distance (non-target area) and an atmospheric feeling are not affected, and a navigation environment is also cleaner and more concise.

The following continues to describe an exemplary structure in which a display apparatus 555 for navigation information provided by an embodiment of this disclosure is implemented as software modules. In some embodiments, as shown in FIG. 2, the software modules in the display apparatus 555 for navigation information stored in a memory 550 may include: a display module 5551, configured to display, in a navigation map interface, a navigation object and at least one map object in a first style; and a switching module 5552, configured to display, in response to a target map object being located in a target area set around the navigation object, a process of the target map object changing from the first style to a second style, the at least one map object including the target map object, and an information amount of the target map object in the second style being less than an information amount of the target map object in the first style.

In some embodiments, the display module 5551 is further configured to display a navigation road in the navigation map interface; display the navigation object on the navigation road; and display, on a periphery of the navigation road, at least one of the map objects in the first style.

In some embodiments, the display module 5551 is further configured to display the navigation object; and display, outside the target area set around the navigation object, at least one of the map objects in the first style.

In some embodiments, the display module 5551 is further configured to display, within the target area set around the navigation object, at least one other map object in the second style, the other map object being a map object other than the at least one map object.

In some embodiments, the navigation object is located in a first lane of a first road in the navigation map interface, and a quantity of the target map objects is plural. The switching module 5552 is further configured to display, for a target map object closest to the first lane among the plurality of target map objects, a process of the closest target map object changing from the first style to the second style.

In some embodiments, the target map object in the first style is a target map object with a first height, and the target map object in the second style is a target map object with a second height. The switching module 5552 is further configured to display a process of the target map object changing from the first height to the second height. The second height is lower than the first height.

In some embodiments, the switching module 5552 is further configured to display, based on a height variation parameter, a process of a map object model of the target map object changing from the first height to the second height.

In some embodiments, in the process of changing from the first height to the second height, the switching module 5552 is further configured to perform, based on a change in height of the map object model, a physical simulation on a change of model texture of the map object model, and display a physically simulated change process of the model texture.

In some embodiments, in the process of changing from the first height to the second height, the switching module 5552 is further configured to control, based on a change in height of the map object model, a model transparency of the map object model to change, and display a changing process of the model transparency.

In some embodiments, the switching module 5552 is further configured to display, when the first height is higher than a height threshold, a process of the target map object changing from the first height to a second height, the second height being lower than the first height; and maintain, when the first height is not higher than the height threshold, the first height of the target map object unchanged, and display, from an aspect different from a height aspect, the process of the target map object changing from the first style to the second style.

In some embodiments, the switching module 5552 is further configured to switch display of the target map object in the first style to display of the target map object in the second style; or display a style switching process in which the target map object switches from the first style, through at least one intermediate style, to the second style. An information amount of the target map object in the intermediate style is less than an information amount of the target map object in the first style, and the information amount of the target map object in the intermediate style is greater than an information amount of the target map object in the second style. When a quantity of the intermediate styles is plural, the information amount of the target map object in the intermediate style is positively correlated with a distance between the target map object in the intermediate style and the navigation object.

In some embodiments, a quantity of the target map objects is plural. The switching module 5552 is further configured to display, for the target map object, when the information amount of the target map object in the first style reaches an information amount threshold of the target map object, the process of the target map object changing from the first style to the second style.

In some embodiments, the switching module 5552 is further configured to determine, in response to the target map object being located in the target area set around the navigation object, a projection size of the target map object in screen space; determine, based on the projection size, a target level of detail corresponding to the target map object; and display the process of the target map object changing from the first style to the second style corresponding to the target level of detail.

In some embodiments, a quantity of the target map objects is plural. The switching module 5552 is further configured to display, for the target map object, when the target map object is located at a target position, the process of the target map object changing from the first style to the second style.

In some embodiments, the display module 5551 is further configured to display a style switching enable control; and enable, in response to an enable instruction for the style switching enable control, a style switching mode for the map object. The switching module 5552 is further configured to display, when the style switching mode is enabled, in response to the target map object being located in the target area set around the navigation object, the process of the target map object changing from the first style to the second style.

In some embodiments, the display module 5551 is further configured to display, after the displaying a process of the target map object changing from the first style to the second style, a style restoration control. The switching module 5552 is further configured to display, in response to a triggering operation for the style restoration control, a process of the target map object changing from the second style to the first style.

In some embodiments, the switching module 5552 is further configured to: display, after the displaying a process of the target map object changing from the first style to the second style, in response to a target map object being located outside a target area set around the navigation object, a process of the target map object changing from the second style to the first style.

In some embodiments, before the displaying a process of the target map object changing from the first style to the second style, the switching module 5552 is further configured to acquire a number of traffic events occurring in a target map object area within a historical time period, the target map object area being an area with the target map object as a center and a first distance as a radius; and determine an information amount that is less than an information amount of the first style and is negatively correlated with the number of traffic events as an information amount of the second style.

Descriptions of the apparatus embodiments in this disclosure are similar to the descriptions of the foregoing method embodiments. The apparatus embodiments have beneficial effects similar to those of the method embodiments, which are not repeated herein. For technical details not fully described in the display apparatus for navigation information provided by the embodiments of this disclosure, understanding may be based on the descriptions of technical details in the foregoing method embodiments.

An embodiment of this disclosure further provides a computer program product. The computer program product includes a computer-executable instruction or a computer program. The computer-executable instruction or the computer program is stored in a computer-readable storage medium. A processor of an electronic device reads the computer-executable instruction or the computer program from the computer-readable storage medium, and the processor executes the computer-executable instruction or the computer program, to enable the electronic device to perform the display method for navigation information provided by the embodiments of this disclosure.

An embodiment of this disclosure further provides a computer-readable storage medium, having a computer-executable instruction or a computer program stored therein. When the computer-executable instruction or the computer program is executed by a processor, the processor is caused to perform the display method for navigation information provided by the embodiments of this disclosure.

In some embodiments, the computer-readable storage medium may be a memory such as a random access memory (RAM), a read-only memory (ROM), a flash memory, a magnetic surface memory, an optical disc, or a compact disc read-only memory (CD-ROM), or may be various devices including one or any combination of the foregoing memories.

In some embodiments, the computer-executable instruction may be written in a form of a program, software, a software module, a script, or code according to a programming language (including a compiler or interpreter language or a declarative or procedural language) in any form, and may be deployed in any form, including an independent program or a module, a component, a subroutine, or another unit suitable for use in a computing environment.

As an example, the computer-executable instructions may, but do not necessarily correspond to, a file in a file system, and may be stored as a part of a file having another program or data stored therein. For example, the computer-executable instructions are stored in one or more scripts in a hypertext markup language (HTML) text, stored in a single file dedicated to a discussed program, or stored in a plurality of collaborative files (for example, files having one or more modules, subprograms, or code parts stored therein).

As an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

The foregoing descriptions are merely some embodiments of this disclosure, and are not intended to limit the protection scope of this disclosure. Any modification, equivalent replacement, and improvement made within the spirit and scope of this disclosure are included in the protection scope of this disclosure.

What is claimed is:

1. A display method, performed by an electronic device, comprising:
displaying, in a navigation map interface, a navigation object and at least one map object in a first style, the at least one map object including a target map object; and
displaying, in response to the target map object being located in a target area set around the navigation object, a process of the target map object changing from the first style to a second style, a first information amount of the target map object in the first style being greater than a second information amount of the target map object in the second style.

2. The method according to claim 1, wherein the displaying the navigation object and the at least one map object in the first style includes:
displaying a navigation road, and displaying the navigation object on the navigation road; and
displaying, on a periphery of the navigation road, the at least one map object using the first style.

3. The method according to claim 1, wherein displaying the navigation object and the at least one map object in the first style includes:
displaying the navigation object; and
displaying, outside the target area, the at least one map object using the first style.

4. The method according to claim 1,
wherein the at least one map object is at least one first map object;
the method further comprising:
displaying, within the target area, at least one second map object using the second style, the at least one second map object being different from the at least one first map object.

5. The method according to claim 1, wherein:
the navigation object is located in a first lane of a first road in the navigation map interface; and
the target map object is one of a plurality of target map objects that is closest to the first lane among the plurality of target map objects.

6. The method according to claim 1, wherein:
the target map object in the first style has a first height, and the target map object in the second style has a second height lower than the first height; and
displaying the process of the target map object changing from the first style to the second style includes:
displaying a process of the target map object changing from the first height to the second height.

7. The method according to claim 6, wherein displaying the process of the target map object changing from the first height to the second height includes:
displaying, based on a height variation parameter, a process of a map object model of the target map object changing from the first height to the second height.

8. The method according to claim 7, further comprising, during the process of changing from the first height to the second height:
performing, based on a change in height of the map object model, a physical simulation on a change of model texture of the map object model, and displaying a physically simulated change process of the model texture.

9. The method according to claim 7, further comprising, during the process of changing from the first height to the second height:
controlling, based on a change in height of the map object model, a model transparency of the map object model to change, and displaying a changing process of the model transparency.

10. The method according to claim 1, wherein displaying the process of the target map object changing from the first style to the second style includes:
displaying, in response to the first height being higher than a height threshold, the process of the target map object changing from the first height to the second height; and
maintaining, in response to the first height being not higher than the height threshold, the first height of the target map object unchanged, and displaying, from an aspect different from a height aspect, the process of the target map object changing from the first style to the second style.

11. The method according to claim 1, wherein displaying the process of the target map object changing from the first style to the second style includes:
switching display of the target map object in the first style to display of the target map object in the second style; or
displaying a style switching process in which the target map object switches from the first style, through at least one intermediate style, to the second style, wherein:
an information amount of the target map object in each of the at least one intermediate style is less than the first information amount and greater than the second information amount; and
in response to the at least one intermediate style including a plurality of intermediate styles, the information amount of the target map object in the plurality of intermediate styles is positively correlated with a distance between the target map object in the plurality of intermediate styles and the navigation object.

12. The method according to claim 1, wherein:
the target map object is one of a plurality of target map objects; and
displaying the process of changing from the first style to the second style includes, for each of the plurality of target map objects:
displaying, in response to the first information amount of the target map object reaching an information amount threshold of the target map object, the process of the target map object changing from the first style to the second style.

13. The method according to claim 1, wherein displaying the process of the target map object changing from the first style to the second style includes:
determining, based on the target area, a projection size of the target map object in screen space;
determining, based on the projection size, a target level of detail corresponding to the target map object; and
displaying the process of the target map object changing from the first style to the second style corresponding to the target level of detail.

14. The method according to claim 1, wherein:
the target map object is one of a plurality of target map objects; and
displaying the process of changing from the first style to the second style includes, for each of the plurality of target map object:
displaying, in response to the target map object being located at a target position, the process of the target map object changing from the first style to the second style.

15. The method according to claim 1, further comprising:
displaying a style switching enable control; and
enabling, in response to an enable instruction for the style switching enable control, a style switching mode for the map object;
wherein displaying, in response to the target map object being located in the target area, the process of the target map object changing from the first style to the second style includes:
displaying, in response to the style switching mode being enabled and the target map object being located in the target area, the process of the target map object changing from the first style to the second style.

16. The method according to claim 1, further comprising:
displaying a style restoration control; and
displaying, in response to a triggering operation for the style restoration control, a process of the target map object changing from the second style to the first style.

17. The method according to claim 1, further comprising:
displaying, in response to the target map object being located outside the target area, a process of the target map object changing from the second style to the first style.

18. The method according to claim 1, further comprising:
obtaining a number of traffic events occurring in a target map object area within a historical time period, the target map object area having the target map object as a center; and
determining an information amount that is less than the first information amount and is negatively correlated with the number of traffic events as the second information amount.

19. An electronic device comprising:
a memory storing computer-executable instructions; and
a processor configured to execute the computer-executable instructions to:
display, in a navigation map interface, a navigation object and at least one map object in a first style, the at least one map object including a target map object; and
display, in response to the target map object being located in a target area set around the navigation object, a process of the target map object changing from the first style to a second style, a first information amount of the target map object in the first style being greater than a second information amount of the target map object in the second style.

20. A non-transitory computer-readable storage medium storing computer-executable instructions that, when executed by a processor, cause an electronic device including the processor to:
display, in a navigation map interface, a navigation object and at least one map object in a first style, the at least one map object including a target map object; and
display, in response to the target map object being located in a target area set around the navigation object, a process of the target map object changing from the first style to a second style, a first information amount of the target map object in the first style being greater than a second information amount of the target map object in the second style.
